(19) United States
(12) Patent Application Publication
(10) Pub. No.: US 2026/0142158 A1
(43) Pub. Date: May 21, 2026

(54) ELECTRODE, SECONDARY BATTERY INCLUDING ELECTRODE, AND METHOD OF MANUFACTURING ELECTRODE

(71) Applicant: SAMSUNG SDI CO., LTD., Yongin-si (KR)

(72) Inventor: Taewoong JANG, Yongin-si (KR)

(21) Appl. No.: 19/211,502

(22) Filed: May 19, 2025

(30) Foreign Application Priority Data
Nov. 19, 2024 (KR) 10-2024-0165055

(51) Int. Cl. H01M 4/36; H01M 4/505; H01M 4/525; H01M 4/58

(52) U.S. Cl. CPC H01M 4/366; H01M 4/505; H01M 4/525; H01M 4/5825

(57) ABSTRACT

An electrode including a substrate, a first composite layer (including one or more active material layers) formed on a first surface of the substrate, and a second composite layer (including two or more active material layers) formed on a second surface of the substrate. The second composite layer includes, in a first area, a double-layered structure including a first active material layer and a second active material layer, and, in a second area, a single-layered structure including one of the first active material layer and the second active material layer. The second area extends at a predetermined length from a terminal end of the second composite layer.

### CROSS-REFERENCE TO RELATED APPLICATION

This application claims priority under 35 U.S.C § 119 to Korean Patent Application No. 10-2024-0165055, filed in the Korean Intellectual Property Office on Nov. 19, 2024, the entire contents of which are hereby incorporated by reference.

### BACKGROUND

### Field

The present disclosure relates to an electrode, a secondary battery including the electrode, and a method of manufacturing the electrode.

### Description of the Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

In general, a positive electrode and a negative electrode of a secondary battery are manufactured by coating a composite layer on a substrate. However, a rigidity of the composite layer becomes weak during the process of manufacturing the positive electrode and the negative electrode. In addition, the electrodes continuously expand or contract during a life cycle of secondary batteries, and cracking may occur at a portion with weak rigidity, which reduces the life span of the secondary batteries.

The above information disclosed in this Background section is for enhancement of understanding of the background of the present disclosure, and therefore, it may contain information that does not constitute related (or prior) art.

### SUMMARY

The present disclosure is aimed to provide an electrode, a secondary battery including an electrode, and a method of manufacturing an electrode for solving the above-described problems.

However, the technical problem to be solved by the present disclosure is not limited to the above problem, and other problems not mentioned herein, and aspects and features of the present disclosure that would address such problems, will be clearly understood by those skilled in the art from the description of the present disclosure below.

According to an embodiment of the present disclosure to solve the above technical problem, an electrode may include a substrate, a first composite layer, including one or more active material layers, formed on a first surface of the substrate, and a second composite layer, including two or more active material layers, formed on a second surface of the substrate. The second composite layer may include in a first area, a double-layered structure including a first active material layer and a second active material layer, and in a second area, a single-layered structure including one of the first active material layer and the second active material layer, wherein the second area extends at a predetermined length from a terminal end of the second composite layer.

In some embodiments, in the second area, the second active material layer may cover a terminal end of the first active material layer on the second surface.

In some embodiments, in the second area, a terminal end of the first active material layer of the second composite layer may be longer than a terminal end of the second active material layer of the second composite layer.

In some embodiments, a terminal end of the first composite layer may be longer than the terminal end of the second composite layer or may be the same as the terminal end of the second composite layer.

In some embodiments, the first composite layer may include, in a third area, a double-layered structure including the first active material layer and the second active material layer, and, in a fourth area, a single-layered structure including one of the first active material layer and the second active material layer.

In some embodiments, in the second area, the second active material layer of the second composite layer may cover a terminal end of the first active material layer of the second composite layer on the second surface, and, in the fourth area, the second active material layer of the first composite layer may cover a terminal end of the first active material layer of the first composite layer on the first surface.

In some embodiments, in the second area, the second active material layer of the second composite layer may cover a terminal end of the first active material layer of the second composite layer on the second surface, and, in the fourth area, a terminal end of the first active material layer of the first composite layer may be longer than a terminal end of the second active material layer of the first composite layer.

In some embodiments, in the second area, a terminal end of the first active material layer of the second composite layer may be longer than a terminal end of the second active material layer of the second composite layer, and, in the fourth area, the second active material layer of the first composite layer may cover a terminal end of the first active material layer of the first composite layer on the first surface.

In some embodiments, in the second area, a terminal end of the first active material layer of the second composite layer may be longer than a terminal end of the second active material layer of the second composite layer, and, in the fourth area, a terminal end of the first active material layer of the first composite layer may be longer than a terminal end of the second active material layer of the first composite layer.

In some embodiments, materials of the first active material layer may include components or compositions that are the same as components or compositions of materials of the second active material layer.

In some embodiments, materials of the first active material layer may include components that are the same as components of materials of the second active material layer, and materials of the first active material layer may include compositions different from compositions of materials of the second active material layer. A content of a binder or of a conductive material included in the first active material layer may be higher than a content of a binder or of a conductive material included in the second active material layer.

In some embodiments, the first active material layer may include a material with a higher output characteristic than all materials of the second active material layer.

In some embodiments, the first active material layer may include at least one of a manganese spinel-based active material and an olivine-based active material.

In some embodiments, the second active material layer may include a material with a higher energy density than all materials of the first active material layer.

In some embodiments, the second active material layer may include a Lithium nickel-cobalt-manganese composite oxide.

According to one or more embodiments of the present disclosure, a secondary battery may include an electrode assembly including a first electrode, a separator, and a second electrode, a case configured to accommodate the electrode assembly, and a cap assembly coupled to an opening of the case and configured to seal the case. At least one of the first electrode or the second electrode may include a substrate, a first composite layer, including one or more active material layers, formed on a first surface of the substrate, and a second composite layer, including two or more active material layers, formed on a second surface of the substrate. The second composite layer may include, in a first area, a double-layered structure including a first active material layer and a second active material layer, and, in a second area, a single-layered structure including one of the first active material layer and the second active material layer. The second area may have a predetermined length in a direction from a terminal end to an initial end of the second composite layer.

In some embodiments, in the second area, the second active material layer of the second composite layer may cover a terminal end of the first active material layer of the second composite layer.

In some embodiments, in the second area, a terminal end of the first active material layer of the second composite layer may be longer than a terminal end of the second active material layer of the second composite layer.

In some embodiments, a terminal end of the first composite layer may be longer than or the same as a terminal end of the second composite layer.

According to one or more embodiments of the present disclosure, a method of manufacturing an electrode may include forming a first composite layer, including one or more active material layers, on a first surface of a substrate, forming a second composite layer on a second surface of the substrate, forming, in a first area, the second composite layer such that the second composite layer includes a first active material layer and a second active material layer from an initial end of the second active material layer to a predetermined point of the substrate, and forming, in a second area, the second composite layer such that the second composite layer includes one of the first active material layer and the second active material layer from the predetermined point of the substrate to a terminal end of the substrate.

According to embodiments of the present disclosure, an occurrence of cracks on electrodes may be prevented by forming a single-layered structure at a point where fatigue failure occurs first on a double-layered composite layer formed on an electrode plate of a secondary battery.

According to embodiments of the present disclosure, the occurrence of cracks may be prevented by reinforcing the structure of an electrode without substantially changing the manufacturing process of electrode plates by changing the structure of a portion of the double-layered composite layer formed on the electrode plate of the secondary battery to a single-layered structure.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings.

FIG. 1 is a view of an electrode according to embodiments of the present disclosure.

FIG. 2 is an enlarged view of area A of FIG. 1.

FIG. 3 is a view of an electrode according to embodiments of the present disclosure.

FIG. 4 is a view of a positive electrode and a negative electrode according to embodiments of the present disclosure.

FIG. 5 is a view of various stages of a method of manufacturing an electrode according to embodiments of the present disclosure.

FIG. 6 is a view of an electrode according to embodiments of the present disclosure.

FIG. 7 is a view of an electrode according to embodiments of the present disclosure.

FIG. 8 is a view of an electrode according to embodiments of the present disclosure.

FIG. 9 is a view of an electrode according to embodiments of the present disclosure.

FIG. 10 is a view of an electrode according to embodiments of the present disclosure.

FIG. 11 is a view of an electrode according to embodiments of the present disclosure.

FIG. 12 is a view of a secondary battery according to embodiments of the present disclosure.

FIG. 13 is a view of an electrode assembly according to embodiments of the present disclosure.

FIG. 14 is an enlarged view of area B of FIG. 13.

FIG. 15 is a method of manufacturing an electrode according to embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

In addition, it will be understood that when a component is referred to as being “linked,” “coupled,” or “connected” to another component, the elements may be directly “coupled,” “linked” or “connected” to each other, or another component may be “interposed” between the components”.

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

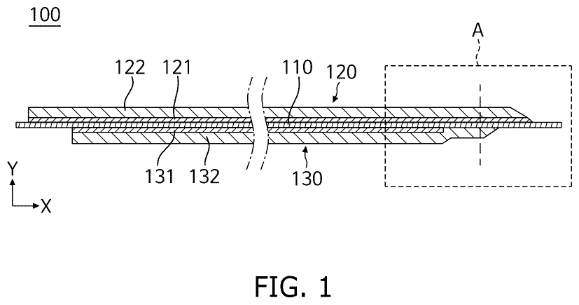

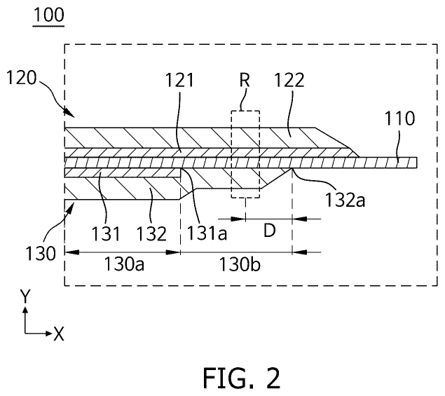

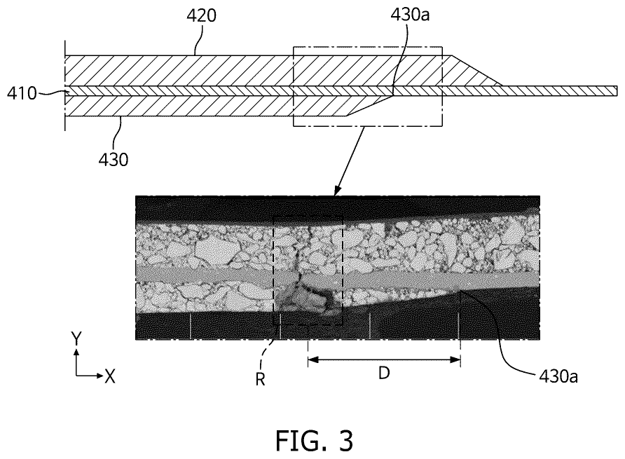

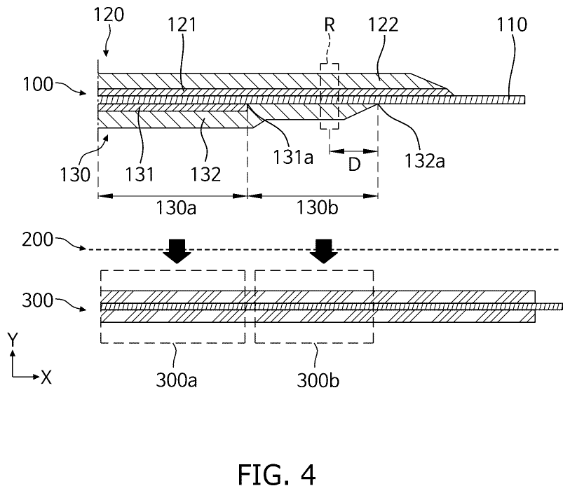

FIG. 1 is a view of an electrode according to embodiments of the present disclosure. FIG. 2 is an enlarged view of area A of FIG. 1. FIG. 3 is a view of an electrode according to embodiments of the present disclosure. FIG. 4 is a view of a positive electrode and a negative electrode according to embodiments of the present disclosure.

Referring to FIG. 1 to FIG. 4, a first electrode 100 according to embodiments of the present disclosure may function as a positive electrode of a secondary battery. The first electrode 100 may include a substrate 110, a first composite layer 120 formed on one surface of the substrate 110, and a second composite layer 130 formed on the other surface of the substrate 110.

The substrate 110 may be a current collector formed of a metal material and formed of a thin plate or a metal film. The substrate 110 may be made of aluminum or aluminum alloy foil.

The first composite layer 120 may be formed on a first surface of the substrate 110, and the second composite layer 130 may be formed on a second surface which is opposite of the first surface. After the first composite layer 120 is coated and formed on the first surface of the substrate 110, the second composite layer 130 may be coated and formed on the second surface of the substrate 110. Each of the first composite layer 120 and the second composite layer 130 may be manufactured by applying an electrode slurry including a binder and a conductive material with an active material on the surface of the substrate 110, and then drying and rolling the surface of the substrate 110 coated with the electrode slurry.

The first composite layer 120 may be formed on the first surface of the substrate 110. The first composite layer 120 may include one or more active material layers formed on the first surface of the substrate 110. For example, the first composite layer 120 may include a first active material layer 121 and a second active material layer 122. The first active material layer 121 of the first composite layer 120 may be formed on the first surface of the substrate 110. In addition, the second active material layer 122 of the first composite layer 120 may be formed on the first active material layer 121.

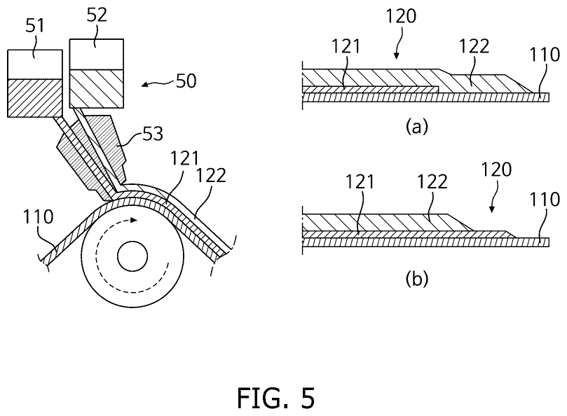

The first composite layer 120 may include the first active material layer 121 and the second active material layer 122 formed by using a double layer slot die coating (DLD) method of a coating device 50 (refer to FIG. 5). A first active material included in the first active material layer 121 and a second active material included in the second active material layer 122 may be the same active material or different active materials.

The second composite layer 130 may be formed on the second surface of the substrate 110. After the first composite layer 120 is formed on the first surface of the substrate 110, the second composite layer 130 may be formed on the second surface of the substrate 110. However, the present disclosure is not limited thereto, but after the second composite layer 130 is formed on the second surface of the substrate 110, the first composite layer 120 may be formed on the first surface of the substrate 110.

The second composite layer 130 may include one or more active material layers formed on the second surface of the substrate 110. The second composite layer 130 may include a first active material layer 131 and a second active material layer 132. The second composite layer 130 may include a first area 130a in a double-layered structure and a second area 130b in a single-layered structure.

The second composite layer 130 may include the first area 130a including the first active material layer 131 and the second active material layer 132 in a double-layered structure. The first area 130a of the second composite layer 130 may have a double-layered structure where the first active material layer 131 is formed on the second surface of the substrate 110, and the second active material layer 132 is formed on the first active material layer 131.

The second composite layer 130 may include the second area 130b connected to the first area 130a and extending to a terminal end of the second composite layer 130 in a single-layered structure including one of the first active material layer 131 and the second active material layer 132. The second area 130b of the second composite layer 130 may have a single-layered structure including one of the first active material layer 131 and the second active material layer 132 on the second surface of the substrate 110.

As shown in FIG. 2, the second active material layer 132 may be formed on the second surface of the substrate 110 by covering a terminal end 131a of the first active material layer 131 in the second area 130b of the second composite layer 130. The terminal end 131a of the first active material layer 131 may be formed longer than a terminal end 132a of the second active material layer 132 in the second area 130b of the second composite layer 130.

The second composite layer 130 may include the first active material layer 131 and the second active material layer 132 formed by using a double layer slot die coating (DLD) method of the coating device 50 (refer to FIG. 5). The first area 130a of the second composite layer 130 may be formed in a double-layered structure by simultaneously coating the first active material layer 131 and the second active material layer 132 from a point where coating begins to a predetermined point on the substrate 110. In addition, the second area 130b of the second composite layer 130 may be formed in a single-layered structure by coating one of the first active material layer 131 and the second active material layer 132 from a predetermined point to a point where the coating ends. The first active material included in the first active material layer 131 and the second active material included in the second active material layer 132 may have the same active material or different active materials.

The second area 130b of the second composite layer 130 may be formed at a predetermined length from the terminal end of the second composite layer 130. Specifically, in the second area 130b of the second composite layer 130, a single-layered structure including one of the first active material layer 131 and the second active material layer 132 may be formed at a predetermined length in an X direction from the terminal end of the second composite layer 130 toward the first area 130a. The length of the second area 130b of the second composite layer 130 may be greater than a length D from the terminal end to a point R where a fatigue failure occurs first on the second composite layer 130. The second area 130b of the second composite layer 130 may be formed at a length that is long enough to cover the point R where a fatigue failure of the second composite layer 130 occurs first.

In some embodiments, the point R where the fatigue failure occurs first may be a point where the second composite layer 130 is primarily damaged during a rolling process. For example, during the process of rolling the first composite layer 120 and the second composite layer 130, a maximum shear stress may be applied to the second composite layer 130 by a step between the second composite layer 130 and the substrate 110, so that the point where the second composite layer 130 is primarily damaged may be the point R where the fatigue failure occurs first.

In some embodiments, the point R where a fatigue failure occurs first may be a point at which the second composite layer 130 of the positive electrode receives secondary damage in an area where the maximum expansion rate of the electrode (e.g., the negative electrode) facing the positive electrode occurs with respect to the separator. For example, during the life cycle of the secondary battery, the electrode may continuously contract and expand, and pressure may be continuously applied to the second composite layer 130 in an area where a maximum expansion rate of the electrode (e.g., the negative electrode) facing the positive electrode occurs. Accordingly, the point at which the secondary damage occurs in the second composite layer 130 corresponding to the area where the maximum expansion rate of the electrode (e.g., the negative electrode) facing the positive electrode occurs may be the point R at which a fatigue failure occurs first.

The length D from the terminal end of the second composite layer 130 (e.g., the terminal end 132a of the second active material layer) to the predetermined point R on the second composite layer 130 where the fatigue failure occurs first may be 0.4 mm to 0.6 mm. In this case, the second area 130b of the second composite layer 130 may be formed to have a length of 1.8 mm to 2.2 mm from the terminal end of the second composite layer 130 (e.g., the terminal end 132a of the second active material layer), which may be long enough to cover the entire length D to the point R at which the fatigue failure occurs first. The length of the second area 130b of the second composite layer 130 is not limited thereto, and the length may vary depending on the point R where the fatigue failure occurs first.

As illustrated in FIG. 3, the electrode may be manufactured by forming a first composite layer 420 on a first surface of a substrate 410 and forming a second composite layer 430 on a second surface of the substrate 410. In the process of rolling the electrode, a point R at which the maximum shear stress is applied may be formed at a location where a step is formed between the substrate 410 and a terminal end 430a of the second composite layer 130. The point R at which the maximum shear stress is applied may be a point at which damage occurs in the second composite layer 430 and the fatigue failure occurs first. In addition, the electrode continuously may contract and expand during the life cycle of the secondary battery, and the fatigue failure may additionally occur at the point R at which the maximum shear stress is applied on the second composite layer 430, which may reduce the life of the secondary battery.

For the first electrode 100, a single-layered structure including one of the first active material layer 131 or the second active material layer 132 may be formed in the second area 130b of the second composite layer 130 to cover a point where the fatigue failure may occur. Accordingly, the fatigue failure caused by an application of the maximum shear stress during the manufacturing process or life cycle of the electrode may be prevented.

Referring to FIG. 4, the first electrode 100 and the second electrode 300 may be placed with a separator 200 interposed therebetween. The first electrode 100 may correspond to the first electrode 100 described in FIG. 1 and FIG. 2 and may be a positive electrode. The second electrode 300 may be a negative electrode having a different polarity from the first electrode 100.

The second area 130b of the second composite layer 130 of the first electrode 100 may be formed in a single-layered structure, so that the amount of lithium ions stored and released during charging and discharging may be smaller than that of the first area 130a formed in a double-layered structure. Accordingly, an amount of lithium ions stored and released in a second area 300b of the second electrode 300 facing the second area 130b of the second composite layer 130 during the charging and discharging process may be smaller than an amount of lithium ions stored and released in a first area 300a of the second electrode 300 facing the first area 130a of the second composite layer 130. In proportion to an amount of lithium ions, an expansion ratio of the second area 300b of the second electrode 300 may be reduced compared to an expansion ratio of the first area 300a of the second electrode 300. In addition, a pressure applied to the second area 130b of the second composite layer 130 of the first electrode facing the second area of the second electrode may also be reduced. By forming a single-layer structured active material layer in the second area 130b of the second composite layer 130 that covers the point R where the fatigue failure occurs first in a conventional electrode structure, a pressure due to expansion of the first electrode 100 and the second electrode 300 occurring during the charging and discharging process may be reduced, thereby preventing cracks from occurring for the first electrode 100.

FIG. 5 is a view of various stages of a method of manufacturing an electrode according to embodiments of the present disclosure.

Referring to FIG. 5, in the coating device 50, the first composite layer 120 including the first active material layer 121 and the second active material layer 122 may be formed on the first surface of the substrate 110.

The coating device 50 may include a first chamber 51 that provides a first slurry for forming the first active material layer 121, a second chamber 52 that provides a second slurry for forming the second active material layer 122, and a slot die 53 that applies the first slurry and the second slurry on the substrate 110. The first slurry and the second slurry may include a positive electrode active material, a binder, and/or a conductive material.

The coating device 50 may apply pressure to the first chamber 51 and apply the first slurry onto the substrate 110 to form the first active material layer 121 on the substrate 110. Further, the coating device 50 may simultaneously or subsequently apply pressure to the second chamber 52 and apply the second slurry onto the substrate 110 to form the second active material layer 122 on the substrate 110.

The coating device 50, as shown in (a) of FIG. 5, may form a double-layered structure where the first active material layer 121 and the second active material layer 122 are coated by simultaneously applying the first slurry and the second slurry on the substrate 110 during a predetermined time period. In addition, the coating device 50 may block the supply of the first slurry after a predetermined time period and may apply only the second slurry onto the substrate 110 to form a single-layered structure where the second active material layer 122 is coated.

The coating device 50, as shown in (b) of FIG. 5, may form a double-layered structure where the first active material layer 121 and the second active material layer 122 are coated by applying the first slurry and the second slurry on the substrate 110 during a predetermined time period. In addition, the coating device 50 may block the supply of the second slurry after a predetermined time period, and apply the first slurry onto the substrate 110 to form a single-layered structure where the first active material layer 121 is coated.

In some embodiments, each of the first active material layer 121 and the second active material layer 122 may have a same material with a same component or a same composition. The first slurry and the second slurry that respectively form the first active material layer 121 and the second active material layer 122 may have a same component and a same composition.

In some embodiments, the first active material layer 121 and the second active material layer 122 may include a material of the same component, but of different compositions. Further, the content of the binder or the conductive material included in the first active material layer 121 may be higher than the content of the binder or the conductive material included in the second active material layer 122. For forming the first active material layer 121 and the second active material layer 122 having such a composition, the first slurry and the second slurry may have the same active material layer, but different contents of the binder or the conductive material. The first slurry forming the first active material layer 121 contacting the substrate 110 may increase the content of the binder or the conductive material than the second slurry that forms the second active material layer 122, thereby improving the adhesion and the conductivity of the first active material layer 121 and the substrate 110.

The first active material layer 121 may include a material having higher output characteristics than some or all materials of the second active material layer 122. The first active material layer 121 may include one of a manganese spinel-based active material and an olivine-based active material, but a composition of the first active material layer 121 is not limited thereto. For example, the manganese spinel-based active material may include a compound represented by the chemical formula Li1+xMn2−yMyO4 (where M is a metal having an oxidation number of divalent or trivalent; 0≤x≤0.2 and 0<y≤0.2). In addition, the olivine-based active material may include a compound represented by the chemical formula LiM′PO4 (where M′ is Fe, Mn, Ni, or V).

The second active material layer 122 may include a material having a higher energy density than some or all materials of the first active material layer 121. For example, the second active material layer 122 may include a lithium nickel-cobalt-manganese composite oxide, but it is not limited thereto. As a further example, the active material including the lithium nickel-cobalt-manganese composite oxide may include a compound represented by the chemical formula LiaNibMncCodMeO2 (where 0.95≤a≤1.05, 0≤b, 0≤c, 0≤d, 0≤e<0.1, 1.95≤a+b+c+d+e≤2.05, and M is a metal having an oxidation number of divalent or trivalent). In addition, the active material including the lithium nickel-cobalt-manganese composite oxide may be an active material satisfying conditions b>c and b>d in which a content of nickel is greater than a content of cobalt and a content of manganese, or an active material satisfying the conditions c>b and c>d in which the content of manganese is greater than the contents of cobalt and nickel.

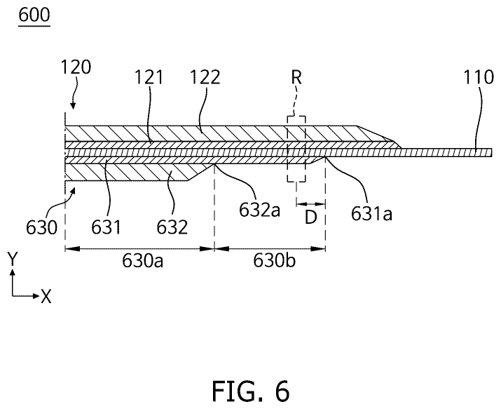

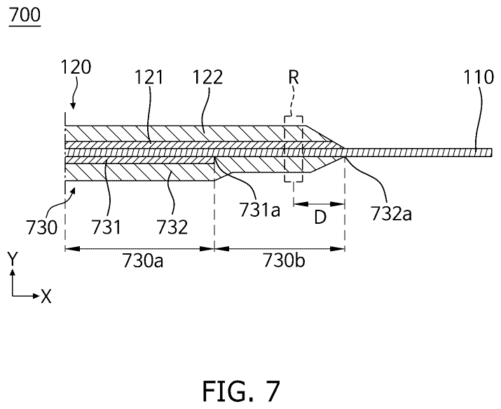

FIG. 6 is a view of an electrode according to embodiments of the present disclosure. FIG. 7 is a view of an electrode according to embodiments of the present disclosure.

Referring to FIG. 6 and FIG. 7, second composite layers 630 and 730 of electrodes 600 and 700 may be formed in a single-layered structure in second areas 630b and 730b.

In comparison with that of the first electrode 100 of FIG. 2, a terminal end 631a of a first active material layer 631 may be formed longer than a terminal end 632a of a second active material layer 632 in the second area 630b of the second composite layer 630.

In addition, in comparison with that of the first electrode 100 of FIG. 2, the terminal end of the first composite layer 120 of FIG. 7 may be longer than or the same as a terminal end of the second composite layer 730. The first composite layer 120 may be coated on the first surface of the substrate 110, and then the second composite layer 730 may be coated on the second surface of the substrate 110. Specifically, during the coating process, after the location of the first composite layer 120 coated on the first surface of the substrate 110 is recognized, the second composite layer 730 may be coated on the second surface of the substrate 110.

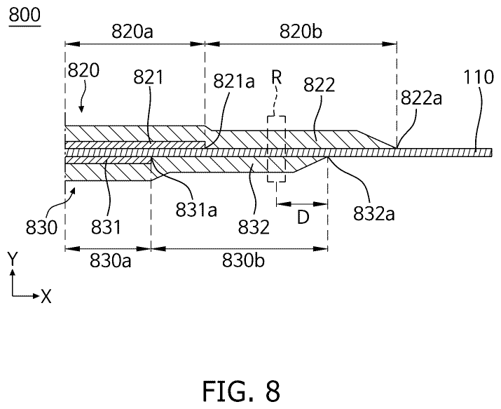

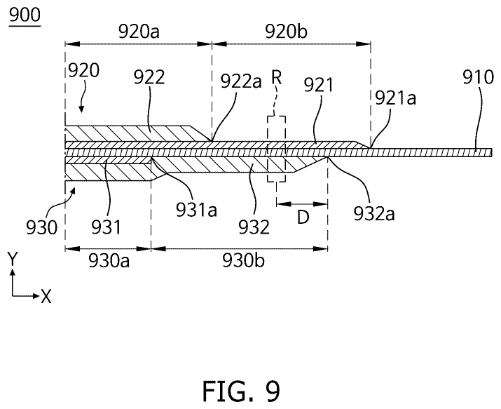

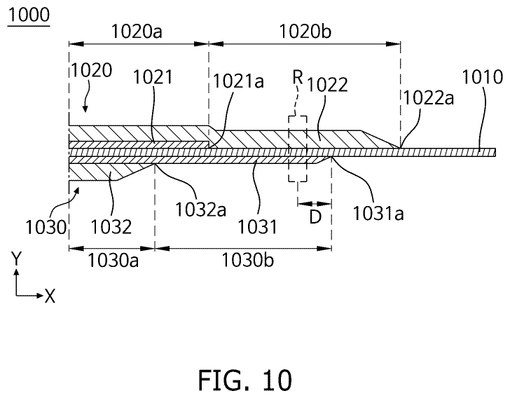

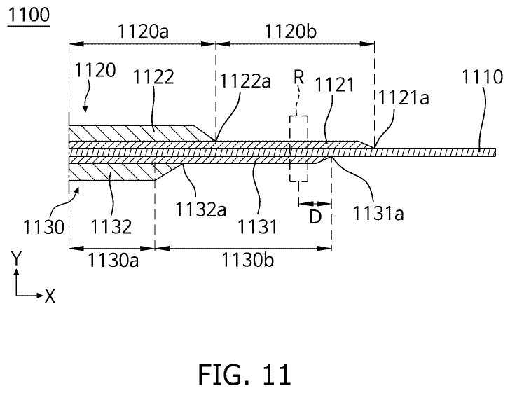

FIG. 8 is a view of an electrode according to embodiments of the present disclosure. FIG. 9 is another view of an electrode according to embodiments of the present disclosure. FIG. 10 is another view of an electrode according to embodiments of the present disclosure. FIG. 11 is another view of an electrode according to embodiments of the present disclosure.

In comparison with the first electrode 100 of FIG. 2, first composite layers 820, 920, 1020, and 1120 of electrodes 800, 900, 1000, and 1100 illustrated in FIGS. 8 to 11 may include third areas 820a, 920a, 1020a, and 1120a of a double-layered structure and fourth areas 820b, 920b, 1020b, and 1120b of a single-layered structure.

The first composite layers 820, 920, 1020, and 1120 may include the third areas 820a, 920a, 1020a, and 1120a in which a double layer structure including first active material layers 821, 921, 1021, and 1121 and second active material layers 822, 922, 1022, and 1122 is formed. The third areas 820a, 920a, 1020a, and 1120a may include a double layer structure in which the first active material layers 821, 921, 1021, and 1121 are formed on first surfaces of substrates 810, 910, 1010, and 1110 and second active material layers 822, 922, 1022, and 1122 are formed on the first active material layers 821, 921, 1021, and 1121.

In addition, the first composite layers 820, 920, 1020, and 1120 may include the fourth areas 820b, 920b, 1020b, and 1120b having a single-layered structure including one of the first active material layers 821, 921, 1021, and 1121 and the second active material layers 822, 922, 1022, and 1122, which are connected to the third areas 820a, 920a, 1020a, and 1120a and extended to the terminal ends of the first composite layers 820, 920, 1020, and 1120. In the fourth areas 820b, 920b, 1020b, and 1120b of the first composite layers 820, 920, 1020, and 1120, a single layer structure including one of the first active material layers 821, 921, 1021, and 1121 and the second active material layers 822, 922, 1022, and 1122 may be formed on the first surface of the substrates 810, 910, 1010, and 1110.

Referring to FIG. 8, a second active material layer 832 may be formed on the second surface in a second area 830b of a second composite layer 830 while covering a terminal end 831a of a first active material layer 831. A fourth area 820b of a first composite layer 820 may have a single-layered structure where a second active material layer 822 is formed on the first surface of the substrate 810 while covering the terminal end 821a of the first active material layer 821.

Referring to FIG. 9, a second active material layer 932 may be formed on the second surface in a second area 930b of a second composite layer 930 while covering a terminal end 931a of a first active material layer 931. A fourth area 920b of the first composite layer 920 may have a single-layered structure where a terminal end 921a of the first active material layer 921 is formed longer than a terminal end 922a of the second active material layer 922.

Referring to FIG. 10, a terminal end 1031a of a first active material layer 1031 may be formed longer than a terminal end 1032a of a second active material layer 1032 in a second area 1030b of a second composite layer 1030. A fourth area 1020b of the first composite layer 1020 may have a single-layered structure where a second active material layer 1022 is formed on the first surface of the substrate 1010 while covering the terminal end 1021a of the first active material layer 1021.

Referring to FIG. 11, in a second area 1130b of a second composite layer 1130, a terminal end 1131a of a first active material layer 1131 may be formed longer than a terminal end 1132a of the second active material layer 1132. A fourth area 1120b of the first composite layer 1120 may have a single-layered structure where a terminal end 1121a of the first active material layer 1121 is formed longer than the terminal end 1122a of the second active material layer 1122.

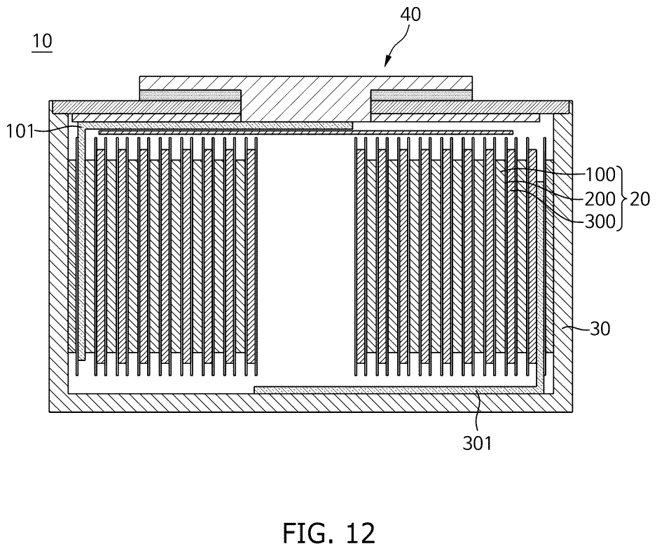

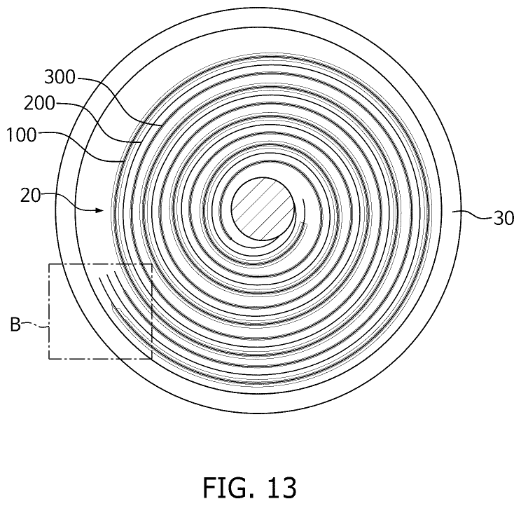

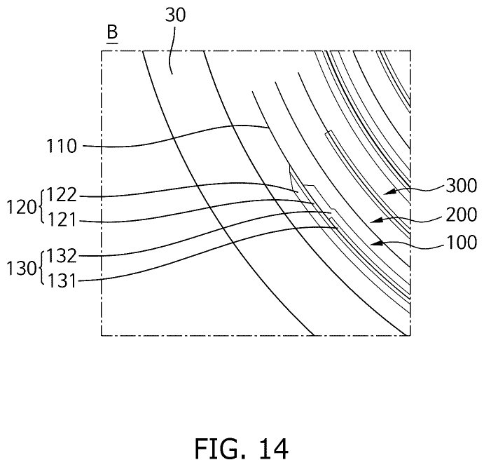

FIG. 12 is a view of a secondary battery according to embodiments of the present disclosure. FIG. 13 is a view of an electrode assembly according to embodiments of the present disclosure. FIG. 14 is an enlarged view of area B of FIG. 13.

Referring to FIG. 12 to FIG. 14, a secondary battery 10 may include an electrode assembly 20 including a first electrode 100, a separator 200, a second electrode 300, a case 30 for accommodating the electrode assembly 20, and a cap assembly 40 coupled to an opening of the case 30 to seal the case 30.

The electrode assembly 20 may be an electrode assembly 20 of a winding type formed by arranging and winding a separator 200, which is an insulator, between the first electrode 100 and the second electrode 300.

The first electrode 100 may function as a positive electrode. The first electrode 100 may include a substrate 110, a first composite layer 120, and a second composite layer 130. The first electrode 100 may correspond to an electrode described in FIG. 1 to FIG. 11.

The second electrode 300 may function as a negative electrode. The second electrode 300 may include a substrate made of copper foil or nickel foil and a negative electrode active material layer coated on both sides of the substrate. The negative electrode active material layer may include, for example, graphite.

The electrode assembly 20 may further include a first electrode tab 101 and a second electrode tab 301. The first electrode tab 101 may be separately formed, and connected to a non-coated part of the first electrode 100, and may be formed by stamping a portion of the non-coated part. The first electrode tab 101 may extend upward from the non-coated part to contact the cap assembly 40. However, the configuration where the first electrode tab 101 contacts the cap assembly 40 is merely exemplary, and the present disclosure is not limited thereto. The first electrode 100 may be electrically connected to the cap assembly 40 because the first electrode tab 101 contacts the cap assembly 40. The second electrode tab 301 may be separately formed and connected to a non-coated part of the second electrode 300 or may be formed by stamping a portion of the non-coated part. The second electrode tab 301 may extend downward from the non-coated part to contact the case 30. The configuration where the second electrode tab 301 contacts the case 30 is merely exemplary, and the present disclosure is not limited thereto. The second electrode 300 may be electrically connected to the case 30 because the second electrode tab 301 contacts the case 30. In some embodiments, the first electrode tab 101 may be electrically connected to the cap assembly 40, and the second electrode tab 301 may be electrically connected to the case 30. In other embodiments, the first electrode tab 101 may be electrically connected to the case 30, and the second electrode tab 301 may be electrically connected to the cap assembly 40.

The case 30 may have one open side to accommodate the electrode assembly 20 and may be electrically connected to the second electrode 300. The case 30 may form the entire exterior of the secondary battery 10. Further, the case 30 may have an open cylindrical shape. The case 30 may have a side wall that vertically extends from the circular-shaped lower surface and the circumference of the lower surface. The diameter of the lower surface of the case 30 may be formed higher than the height of the side wall, so that the secondary battery 10 may be a button-type or a coin-type.

The cap assembly 40 may seal the electrode assembly 20 from the outside by covering one open side of the case 30. The cap assembly 40 may be electrically connected to the first electrode 100 of the electrode assembly 20.

Referring to FIGS. 13 and 14, the first electrode 100 and the second electrode 300 may be placed with the separator 200 interposed therebetween. The second area 130b (refer to FIG. 2) of the second composite layer 130 of the first electrode 100 may be formed in a single-layered structure, and an amount of lithium ions stored and an amount of lithium ions released may be smaller than that of the first area 130a (refer to FIG. 2) formed in a double-layered structure. Accordingly, during the charging and discharging process, with the separator 200 disposed therebetween, the amount of lithium ions stored and released in the second area 300b of the second electrode 300 that faces the second area 130b of the second composite layer 130 may be smaller than the amount of lithium ions stored and released in the first area 300a of the second electrode 300 that faces the first area 130a of the second composite layer 130. In proportion to the amount of lithium ions, the expansion ratio of the second area 300b of the second electrode 300 may be reduced compared to the first area 300a of the second electrode 300. Accordingly, the pressure applied to the second area 130b of the second composite layer 130 of the first electrode may be reduced. A crack occurrence of the first electrode 100 may be prevented by forming a single-layer structured active material layer in the second area 130b of the second composite layer 130 that covers the point R where the fatigue failure occurs first.

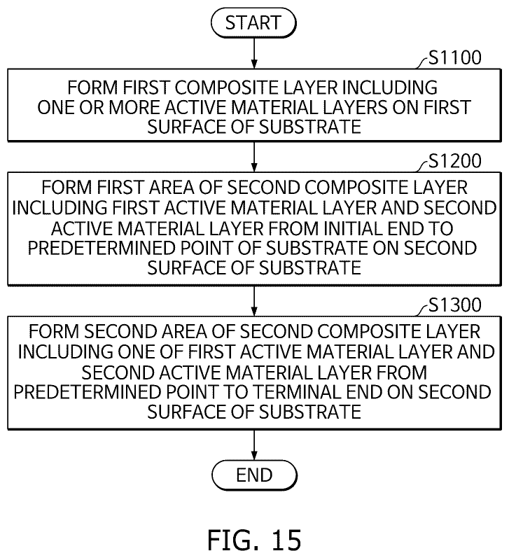

FIG. 15 is a method of manufacturing an electrode according to embodiments of the present disclosure.

Referring to FIG. 15, a method of manufacturing an electrode may include forming a first composite layer including at least one active material layer on a first surface of a substrate in step S1100, forming a first area of a second composite layer including a first active material layer and a second active material layer from an initial end to a predetermined point on a second surface of the substrate in step S1200 and forming a second area of a second composite layer including any one of the first active material layer and the second active material layer from a predetermined point to a terminal end on the second surface of the substrate in step S1300.

Referring to FIG. 2 and FIG. 5, in step S1100, a first composite layer may be formed including one or more active material layers on the first surface of the substrate 110 of the first electrode 100. Further, the first composite layer 120 including the first active material layer 121 and the second active material layer 122 may be formed on the first surface of the substrate 110 by using a double layer slot die coating (DLD) method of the coating device 50.

In step S1200, the first area 130a of the second composite layer 130 including the first active material layer 131 and the second active material layer 132 may be formed from an initial end to a predetermined point on the second surface of the substrate 110. The double-layered structure including the first active material layer 131 and the second active material layer 132 may be formed in the first area 130a. The first area 130a of the second composite layer 130 may have a double-layered structure where the first active material layer 131 is formed on the second surface and the second active material layer 132 is formed on the second surface of the substrate 110.

In step S1300, the second area 130b of the second composite layer 130 including any one of the first active material layer 131 and the second active material layer 132 may be formed from a predetermined point to a terminal end on the second surface of the substrate 110. A single-layered structure including any one of the first active material layer 131 and the second active material layer 132 may be formed on the second surface of the substrate 110 in the second area 130b of the second composite layer 130. As shown in FIG. 2, in the second area 130b of the second composite layer 130, the second active material layer 132 may be formed on the second surface of the substrate 110 by covering the terminal end 131a of the first active material layer 131. Moreover, as shown in FIG. 6, the terminal end 631a of the first active material layer 631 may be formed longer than the terminal end 632a of the second active material layer 632 in the second area 630b of the second composite layer 630. The second area 630b of the second composite layer 630 may be formed by a predetermined length from a terminal end of the second composite layer 630. The length of the second area 630b of the second composite layer 630 may be formed longer than a length D to a point R where a fatigue failure of the second composite layer 630 occurs first. The second area 630b of the second composite layer 630 may be formed at a length that is long enough to cover the point R where the fatigue failure of the second composite layer 630 occurs first.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. An electrode, comprising:
a substrate;
a first composite layer, including one or more active material layers, formed on a first surface of the substrate; and
a second composite layer, including one or more active material layers, formed on a second surface of the substrate,
wherein the second composite layer includes:
in a first area, a double-layered structure including a first active material layer and a second active material layer; and
in a second area, a single-layered structure including one of the first active material layer and the second active material layer, wherein the second area extends at a predetermined length from a terminal end of the second composite layer.

2. The electrode as claimed in claim 1, wherein, in the second area, the second active material layer covers a terminal end of the first active material layer on the second surface.

3. The electrode as claimed in claim 1, wherein, in the second area, a terminal end of the first active material layer of the second composite layer is longer than a terminal end of the second active material layer of the second composite layer.

4. The electrode as claimed in claim 1, wherein a terminal end of the first composite layer is longer than the terminal end of the second composite layer or is the same as the terminal end of the second composite layer.

5. The electrode as claimed in claim 1, wherein the first composite layer includes:
in a third area, a double-layered structure including the first active material layer and the second active material layer; and
in a fourth area, a single-layered structure including one of the first active material layer and the second active material layer.

6. The electrode as claimed in claim 5, wherein, in the second area, the second active material layer of the second composite layer covers a terminal end of the first active material layer of the second composite layer on the second surface, and
wherein, in the fourth area, the second active material layer of the first composite layer covers a terminal end of the first active material layer of the first composite layer on the first surface.

7. The electrode as claimed in claim 5, wherein, in the second area, the second active material layer of the second composite layer covers a terminal end of the first active material layer of the second composite layer on the second surface, and
wherein, in the fourth area, a terminal end of the first active material layer of the first composite layer is longer than a terminal end of the second active material layer of the first composite layer.

8. The electrode as claimed in claim 5, wherein, in the second area, a terminal end of the first active material layer of the second composite layer is longer than a terminal end of the second active material layer of the second composite layer, and
wherein, in the fourth area, the second active material layer of the first composite layer covers a terminal end of the first active material layer of the first composite layer on the first surface.

9. The electrode as claimed in claim 5, wherein, in the second area, a terminal end of the first active material layer of the second composite layer is longer than a terminal end of the second active material layer of the second composite layer, and
wherein, in the fourth area, a terminal end of the first active material layer of the first composite layer is longer than a terminal end of the second active material layer of the first composite layer.

10. The electrode as claimed in claim 1, wherein materials of the first active material layer include components or compositions that are the same as components or compositions of materials of the second active material layer.

11. The electrode as claimed in claim 1, wherein materials of the first active material layer include components that are the same as components of materials of the second active material layer, and materials of the first active material layer include compositions different from compositions of materials of the second active material layer, and
wherein a content of a binder or of a conductive material included in the first active material layer is higher than a content of a binder or of a conductive material included in the second active material layer.

12. The electrode as claimed in claim 1, wherein the first active material layer includes a material with a higher output characteristic than all materials of the second active material layer.

13. The electrode as claimed in claim 12, wherein the first active material layer includes at least one of a manganese spinel-based active material and an olivine-based active material.

14. The electrode as claimed in claim 1, wherein the second active material layer includes a material with a higher energy density than all materials of the first active material layer.

15. The electrode as claimed in claim 14, wherein the second active material layer includes a Lithium nickel-cobalt-manganese composite oxide.

16. A secondary battery, comprising:
an electrode assembly including a first electrode, a separator, and a second electrode;
a case configured to accommodate the electrode assembly; and
a cap assembly coupled to an opening of the case and configured to seal the case,
wherein at least one of the first electrode or the second electrode includes:
a substrate;
a first composite layer, including one or more active material layers, formed on a first surface of the substrate; and
a second composite layer, including one or more active material layers, formed on a second surface of the substrate,
wherein the second composite layer includes:
in a first area, a double-layered structure including a first active material layer and a second active material layer; and
in a second area, a single-layered structure including one of the first active material layer and the second active material layer, wherein the second area has a predetermined length in a direction from a terminal end to an initial end of the second composite layer.

17. The secondary battery as claimed in claim 16, wherein, in the second area, the second active material layer of the second composite layer covers a terminal end of the first active material layer of the second composite layer.

18. The secondary battery as claimed in claim 16, wherein, in the second area, a terminal end of the first active material layer of the second composite layer is longer than a terminal end of the second active material layer of the second composite layer.

19. The secondary battery as claimed in claim 16, wherein a terminal end of the first composite layer is longer than or the same as a terminal end of the second composite layer.

20. A method of manufacturing an electrode, the method comprising:
forming a first composite layer, including one or more active material layers, on a first surface of a substrate;
forming a second composite layer on a second surface of the substrate;
forming, in a first area, the second composite layer such that the second composite layer includes a first active material layer and a second active material layer from an initial end of the second active material layer to a predetermined point of the substrate; and
forming, in a second area, the second composite layer such that the second composite layer includes one of the first active material layer and the second active material layer from the predetermined point of the substrate to a terminal end of the substrate.
